(19) United States
(12) Patent Application Publication
(10) Pub. No.: US 2022/0219979 A1
(43) Pub. Date: Jul. 14, 2022

(54) METHODS FOR PRODUCING ANHYDROUS HYDROGEN IODIDE (HI)

(71) Applicant: Honeywell International Inc., Charlotte, NC (US)

(72) Inventors: Yuon Chiu, Denville, NJ (US); Haiyou Wang, Amherst, NY (US); Haluk Kopkalli, Staten Island, NY (US); Christian Jungong, Depew, NY (US); Haridasan K. Nair, Williamsville, NY (US); Rajiv Ratna Singh, Getsville, NY (US); Daniel C. Merkel, Orchard Park, NY (US); Tao Wang, Shanghai (CN); Terris Yang, Amherst, NY (US); Richard Wilcox, West Caldwell, NJ (US)

(21) Appl. No.: 17/572,544

(22) Filed: Jan. 10, 2022

Related U.S. Application Data
(60) Provisional application No. 63/137,470, filed on Jan. 14, 2021.

(51) Int. Cl. C01B 7/13; B01D 3/06; B01D 3/36; B01D 53/02; B01D 53/14

(52) U.S. Cl. CPC C01B 7/135; B01D 3/065; B01D 3/36; B01D 53/02; C01P 2006/82; B01D 2252/40; B01D 2252/10; B01D 2253/112; B01D 2257/80; B01D 53/14

(57) ABSTRACT

A method of removing water from a mixture of hydrogen iodide (HI) and water includes providing a mixture comprising hydrogen iodide and water and contacting the mixture with an adsorbent to selectively adsorb water from the mixture, contacting the mixture with a weak acid to absorb water from the mixture and/or separating the water from hydrogen iodide (HI) by azeotropic distillation to produce anhydrous hydrogen iodide (HI).

### CROSS-REFERENCE TO RELATED APPLICATION

This application claims priority to Provisional Application No. 63/137,470, filed Jan. 14, 2021, which is herein incorporated by reference in its entirety.

### FIELD

The present disclosure relates to processes for producing anhydrous hydrogen iodide (HI). Specifically, the present disclosure relates to methods of removing water from hydrogen iodide (HI) using adsorption, absorption and/or distillation.

### BACKGROUND

Anhydrous hydrogen iodide (HI) is an important industrial chemical that may be used in the preparation of hydroiodic acid, organic and inorganic iodides, iodoalkanes, and as a reducing agent. In commercial production of hydrogen iodide (HI) and iodine (I₂) can be used as the starting material as shown below in Equation 1.

H₂+I₂→2HI. Equation 1:

The raw materials, (iodine and hydrogen) contain water which may be entrained with HI. The presence of water in hydrogen iodide (HI) creates hydroiodic acid which is corrosive to most alloys, thereby causing damage to downstream manufacturing and processing equipment. Additionally, water, iodine (I₂) and HI can form a ternary mixture. The presence of water could result in the formation of this mixture, which may have a detrimental impact on product separation resulting in reduced yields.

Some methods for drying hydrogen iodide (HI) are known in the art. For example, drying hydrogen halides with magnesium chloride (MgCl₂) on activated carbon has been previously described in EP 1092678A2; however, this reagent is not commercially available and expensive to produce, making it cumbersome to consider for drying hydrogen iodide (HI) on an industrial scale.

What is needed is a method to produce hydrogen iodide (HI) that is substantially free of water on an industrial scale.

### SUMMARY

The present application provides methods for removing water from mixtures comprising water and hydrogen iodide (HI).

In one embodiment, a method of removing water from a mixture of hydrogen iodide (HI) and water includes providing a mixture comprising hydrogen iodide and water and contacting the mixture with an adsorbent to selectively adsorb water from the mixture.

In another embodiment, a method of removing water from a mixture of hydrogen iodide (HI) and water includes providing a mixture comprising hydrogen iodide and water and contacting the mixture with a weak acid to absorb water from the mixture.

In another embodiment, a method of removing water from a mixture of hydrogen iodide (HI) and water includes providing a mixture of hydrogen iodide and water and separating the water from hydrogen iodide (HI) by azeotropic distillation to produce anhydrous hydrogen iodide (HI).

### DESCRIPTION OF THE DRAWINGS

FIG. 1 is a process flow diagram showing an integrated process for manufacturing anhydrous hydrogen iodide.

FIG. 2 is a process flow diagram showing another integrated process for manufacturing anhydrous hydrogen iodide.

### DETAILED DESCRIPTION

The present disclosure provides methods for removing water from a mixture including hydrogen iodide (HI) and water using solid adsorbents, liquid absorbents, distillation or any combination thereof. Hydrogen iodide (HI) may be produced by the gas phase reaction of hydrogen (H₂) and iodine (I₂) according to Equation 1 above.

The anhydrous hydrogen iodide is substantially free of water. That is, any water in the anhydrous hydrogen iodide is in an amount by weight less than about 500 parts per million, about 300 ppm, about 200 ppm, about 100 ppm, about 50 ppm, about 30 ppm, about 20 ppm, about 10 ppm, about 5 ppm, about 3 ppm, about 2 ppm, or about 1 ppm, or less than any value defined between any two of the foregoing values. Preferably, the anhydrous hydrogen iodide comprises water by weight in an amount less than about 100 ppm. More preferably, the anhydrous hydrogen iodide comprises water by weight in an amount less than about 10 ppm. Most preferably, the anhydrous hydrogen iodide comprises water by weight in an amount less than about 1 ppm.

Briefly, the manufacturing process to make anhydrous hydrogen iodide (HI) via the above reaction comprises the following steps: i) vaporization of solid iodine (I₂), ii) catalytic gas phase reaction of iodine (I₂) and hydrogen (H₂) in a reactor, iii) iodine (I₂) recovery and recycling, iv) recovery/recycling of hydrogen (H₂) and hydrogen iodide (HI), and v) product purification. The process is described in greater detail below.

In the context of these processes, there are at least two sources of undesired water. First, both starting materials—iodine (I₂) and hydrogen (H₂) contain certain levels of water. Second, while handling the starting materials, particularly iodine (I₂), water ingress is inevitable. The water thereby brought to the process may become concentrated within the process. The elevated level of water may have several detrimental impacts, including, but not limited to, catalyst deactivation, accelerated corrosion of equipment, and lowered yields as a result of increased side reactions.

In some embodiments, the concentration of water in the mixture including hydrogen iodide and water from which water is to be removed can be as low as about 100 ppm, about 200 ppm, about 400 ppm, about 600 ppm, about 800 ppm, about 1,000 ppm or about 1,200 ppm, or as high as about 1,400 ppm, about 1,600 ppm, about 1,800 ppm, about 2,000 ppm, about 2,200 ppm or about 2,500 ppm or be within any range defined between any two of the foregoing values, such as, about 100 ppm to about 2,500 ppm, about 200 ppm to about 2,200 ppm, about 400 ppm to about 2,000 ppm, about 600 ppm to about 1,800 ppm, about 800 ppm to about 1,600 ppm, about 1,000 ppm to about 1,400 ppm, about 1,000 ppm to about 1,200 ppm, about 1,600 ppm to about 2,500 ppm, or about 1,000 ppm to about 1,600 ppm, for example. Preferably, the concentration of water in the mixture including hydrogen iodide and water from which water is to be removed is from about 200 ppm to about 2,200 ppm. More preferably, the concentration of water in the mixture including hydrogen iodide and water from which water is to be removed is from about 600 ppm to about 1,800 ppm. Most preferably, the concentration of water in the mixture including hydrogen iodide and water from which water is to be removed is from about 600 ppm to about 1,600 ppm. The above water concentrations are by weight.

The present disclosure provides several methods for the removal of water from hydrogen iodide (HI) in either gas or liquid phase. In some embodiments, the water is removed by an adsorbent. The adsorbent must be compatible with hydrogen iodide (HI) and, in some embodiments, (I₂) which may also be present. The adsorbent must possess the capacity to selectively adsorb water rather than the hydrogen iodide (HI) and iodine (I₂) themselves. The reactivity of hydrogen iodide (HI) makes it incompatible with most industrial desiccants, making this method challenging. As discussed further below, various modifications of the procedure described herein can be used to dry hydrogen iodide (HI) by the appropriate selection of adsorbent and conditions. Additionally, the ability to regenerate the adsorbent is desirable. The present disclosure also provides a method by which water can be removed from a mixture of hydrogen iodide (HI) and water by an absorbent. The present disclosure also provides a method by which water can be removed from a mixture of hydrogen iodide (HI) and water using distillation.

### Removal of Water by Nickel(II) Iodide Adsorbent

The present disclosure provides a method comprising the removal of water with nickel(II) iodide (NiI₂). Nickel(II) iodide may be used as a desiccant for scavenging water in hydrogen iodide (HI). The nickel(II) iodide may be used in bulk form or supported on a support, such as alumina, silicon carbide, or carbon (e.g., activated carbon), for example. Without being bound by theory, nickel(II) iodide supported on alumina may react with water to form the corresponding hexahydrate (NiI₂.(H₂O)₆).

Although, NiI₂·(H₂O)₆ is deliquescent, its high, water removal capacity makes it a suitable candidate for removal of water from HI. Following the formation of the hydrated complex, the desiccant can be regenerated at temperatures as low as 200° C., as confirmed by thermogravimetric analysis (TGA). The regenerating agent is typically heated nitrogen or air.

### Removal of Water by Commercially Available Adsorbents

The present disclosure further provides the removal of water from hydrogen iodide (HI) through the use of commercially available adsorbents. Several adsorbents were evaluated to determine their ability to selectively adsorb water rather than hydrogen iodide (HI). Specifically, as described in further detail below, activated alumina F-200, activated alumina CLR-204, calcium nitrate on Sorbead WS (aluminosilicate gel), dried/calcined hydrotalcites, synthetic zeolite and zinc phosphate (Zn₃(PO₄)₂) were evaluated and found to selectively adsorb water in preference to HI, to varying degrees. Calcium sulfate (CaSO₄) is also believed to be able to selectively adsorb water rather than hydrogen iodide (HI) and to be compatible with hydrogen iodide (HI). Other suitable commercially available adsorbents include P-188 alumina from UOP, XH9 activated alumina, synthetic zeolites and silica gel. The adsorbent may be used in bulk form or supported on a support, such as alumina, silicon carbide, or carbon (e.g., activated carbon), for example.

Once the adsorbent is spent, that is, it has adsorbed enough water that it can no longer provide sufficient removal of water, it can be regenerated by heating in, for example, dry nitrogen or dry air. The adsorbent may be regenerated by heating the adsorbent to a temperature as low as about 150° C., about 175°, about 200° C., about 225° C. or about 250° C., or as high as about 275° C., about 300° C., about 325° C. or about 350° C., or to a temperature within any range defined between any two of the foregoing values, such as about 150° C. to about 350° C., about 175° C. to about 325° C., about 200° C. to about 300° C., about 225° C. to about 300° C., about 150° C. to about 250° C., or about 200° C. to about 300° C., for example.

In use, in some embodiments, the flow rate of the water/HI mixture through the adsorbent maintained high enough to overcome the initial high heat of adsorption, thereby maintaining the temperature of the liquid hydrogen iodide (HI) and the adsorbent bed at 65° C. or lower. This can prevent the formation of hot spots in the adsorbent bed which could otherwise lead to the decomposition of the HI or damage to the adsorbent.

### Removal of Water by Silicalite Adsorbent

Yet another method provided by the present disclosure is the removal of water from hydrogen iodide (HI) with silicalite. Slicalite is a porous form of SiO₂. Silicalite is compatible with hydrogen iodide (HI), which, as aforementioned, may be a difficult characteristic to find in an absorbent. As described in further detail below, silicalite was determined to have a high water removal capacity, making it a suitable candidate for removal of water from hydrogen iodide (HI).

Once the adsorbent is spent, it can be regenerated by heating in, for example, dry nitrogen or dry air. The adsorbent may be regenerated by heating the adsorbent to a temperature as low as about 150° C., about 175°, about 200° C., about 225° C. or about 250° C., or as high as about 275° C., about 300° C., about 325° C. or about 350° C., or to a temperature within any range defined between any two of the foregoing values, such as about 150° C. to about 350° C., about 175° C. to about 325° C., about 200° C. to about 300° C., about 225° C. to about 300° C., about 150° C. to about 250° C., or about 200° C. to about 300° C., for example.

Removal of Water by Absorption into Weak Acid

The present disclosure further provides a method by which water can be removed from hydrogen iodide (HI) by absorption into acid. Suitable weak acids include phosphoric acid (H₃PO₄), meta-phosphoric acid (HPO₃), and acetic acid (CH₃CO₂H), for example. As defined herein, a weak acid is an acid having an acid ionization constant, Kₐ less than 1. Preferably, the weak acid is phosphoric acid.

In some embodiments, water may be removed from vapor phase hydrogen iodide by mixing the hydrogen iodide (HI) vapor with liquid weak acid in a gas-liquid mixing contactor. The contactor may be operated at atmospheric pressure or higher, and at ambient temperature or higher. The dried hydrogen iodide (HI) vapor may exit the contactor and pass downstream for further purification, if desired.

The gas-liquid mixing contactor may be a counter-current packed or trayed tower. The hydrogen iodide (HI) vapor may be fed into the contactor from the bottom and may exit at the top. The liquid weak acid may be fed into the contractor from the top and may exit from the bottom. Alternatively, the contactor may be a co-current packed or trayed tower in which both the hydrogen iodide (HI) vapor and liquid weak acid flow in the same direction.

In some embodiments, water may be removed from liquid hydrogen iodide by mixing liquid hydrogen iodide (HI) with liquid weak acid in a liquid-liquid mixing contactor. The contactor may be operated at 100 psig or higher, and at ambient temperature or higher. The dried hydrogen iodide (HI) liquid may exit the contactor and pass downstream for further purification, if desired.

The liquid weak acid absorbent may be recycled when it is no longer sufficiently capable of absorbing water. When phosphoric acid is used, a purge of the phosphoric acid may remove the absorbed water, which could be sent to a separate unit operation for further treatment to recover any residual hydrogen iodide.

In another alternative method, the contactor may be a mixing tank in which the hydrogen iodide (HI) and weak acid are thoroughly mixed. The contactor may also be an eductor, in which liquid weak acid circulates through the eductor may be mixed with hydrogen iodide (HI) passing through the eductor. The hydrogen iodide (HI) may be in vapor phase or liquid phase.

The contactor need not be a single unit, but may alternatively be multiple units in series in order to increase the absorption of water from the hydrogen iodide (HI) vapor into the liquid weak acid. This results in lowered use of weak acid, thereby resulting in a more economical process.

### Removal of Water by Azeotropic Distillation or Multi-Stage Flash

The present disclosure also provides a method to remove water from a mixture of hydrogen iodide (HI) and water by azeotropic distillation. Hydrogen halide compounds are known to form high boiling point azeotropes with water, allowing water to be separated from the hydrogen halide by distillation. Dried HI will be distilled in the overhead, leaving behind a bottom composition richer in water which may further be treated in any of the methods described above. Azeotropic distillation includes both pressure swing and extractive distillation.

With a multi-stage flash setup, water removal and iodine (I₂) recovery efficiency approaches or exceeds that achieved with a distillation column. Examples 7 and 8 (below) show the wide range of water removal and product yield achieved by varying the number of separation stages and reflux ratios.

In some embodiments, the pressure can be as low as about 10 psia, about 20 psia, about 40 psia, about 60 psia, about 80 psia about, or about 100 psia, or as high as about 150 psia, about 200 psia, about 250 psia, about 300 psia, about 350 psia or about 400 psia, or be within any range defined between any two of the foregoing values, such as about 10 psia to about 400 psia, about 20 psia to about 350 psia, about 40 psia to about 300 psia, about 60 psia to about 250 psia, about 80 psia to about 200 psia, about 100 psia to about 150 psia or about 20 psia to about 200 psia, for example. Preferably, the pressure is from about 80 psia to about 300 psia. More preferably, the pressure is from about 100 psia to about 250 psia. Most preferably, the pressure is from about 150 psia to about 200 psia.

In some embodiments, the temperature can be as low as about −45° C., about −40° C., about −35° C., about −30° C., about −25° C., about −20° C., about −15° C., about −10° C., about −5° C. or about 0° C.,or as high as about 5° C., about 10° C., about 15° C., about 20° C., about 25° C., about 30° C., about 35° C., about 40° C., about 45° C., about 50° C., about 55° C. or about 60° C., or be within any range defined between any two of the foregoing values, such as about −45° C. to about 60° C., about −40° C. to about 50° C., about −35° C. to about 40° C., about −30° C. to about 30° C., about −25° C. to about 25° C., about −20° C. to about 20° C., about −15° C. to about 15° C., about −10° C. to about 10° C., about −5° C. to about 5° C., about −15° C. to about 0° C., or about −0° C. to about 20° C., for example. Preferably, the temperature is from about 15° C. to about 60° C. More preferably, the temperature is from about 25° C. to about 55° C. Most preferably, the temperature is from about 40° C. to about 50° C.

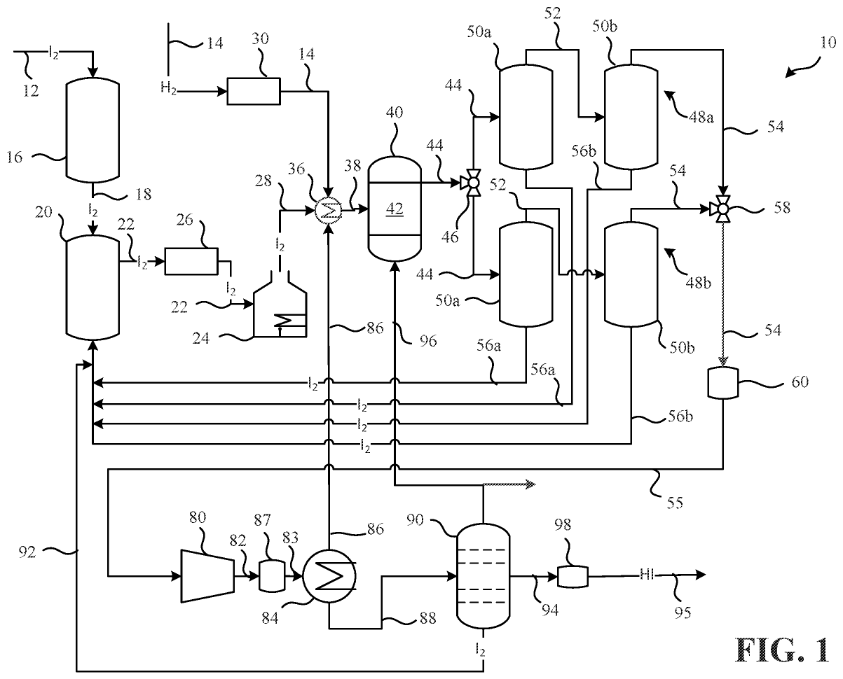

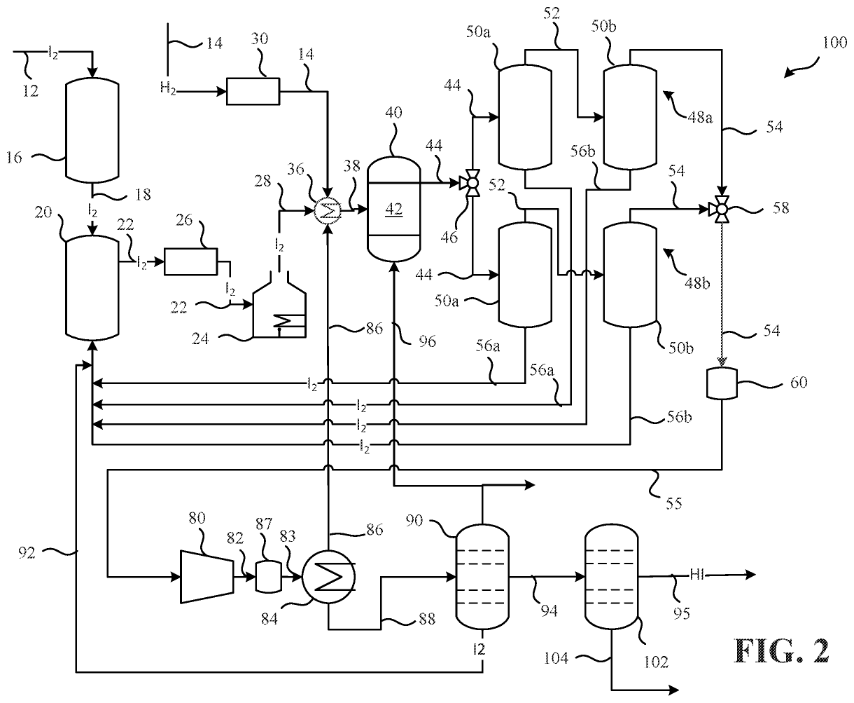

Although the methods for removing water from a mixture including hydrogen iodide (HI) and water are described above using solid adsorbents, liquid absorbents and azeotropic distillation alone, it is understood that embodiments include any combination of any of the methods described above, as illustrated in FIGS. 1 and 2, for example.

An integrated process may be used for the manufacture of hydrogen iodide. FIG. 1 is a process flow diagram showing this process. As shown in FIG. 1, an integrated process 10 includes material flows of solid iodine 12 and hydrogen gas 14. The solid iodine 12 may be continuously or intermittently added to a solid storage tank 16. A flow of solid iodine 18 is transferred, continuously or intermittently, by a solid conveying system (not shown) or by gravity from the solid storage tank 16 to an iodine liquefier 20 where the solid iodine is heated to above its melting point but below its boiling point to maintain a level of liquid iodine in the iodine liquefier 20. Although only one liquefier 20 is shown, it is understood that multiple liquefiers 20 may be used in a parallel arrangement. Liquid iodine 22 flows from the iodine liquefier 20 to an iodine vaporizer 24. The iodine liquefier 20 may be pressurized by an inert gas to drive the flow of liquid iodine 22. The inert gas may include nitrogen, argon, or helium, or mixtures thereof, for example. Alternatively, or additionally, the flow of liquid iodine 22 may be driven by a pump (not shown). The flow rate of the liquid iodine 22 may be controlled by a liquid flow controller 26. In the iodine vaporizer 24, the iodine is heated to above its boiling point to form a flow of iodine vapor 28.

The flow rate of the hydrogen 14 may be controlled by a gas flow controller 30. The flow of iodine vapor 28 and the flow of hydrogen 14 are provided to a superheater 36 and heated to the reaction temperature to form a reactant stream 38. The reactant stream 38 is provided to a reactor 40.

The reactant stream 38 reacts in the presence of a catalyst 42 contained within the reactor 40 to produce a product stream 44. The catalyst 42 may be any of the catalysts described herein. The product stream 44 may include hydrogen iodide, unreacted iodine, unreacted hydrogen and trace amounts of water and other high boiling impurities.

The product stream 44 may be provided to an upstream valve 46. The upstream valve 46 may direct the product stream 44 to an iodine removal step. Alternatively, the product stream 44 may pass through a cooler (not shown) to remove some of the heat before being directed to the iodine removal step. In the iodine removal step, a first iodine removal train 48a may include a first iodine removal vessel 50a and a second iodine removal vessel 50b. The product stream 44 may be cooled in the first iodine removal vessel 50a to a temperature below the boiling point of the iodine to condense or desublimate at least some of the iodine, separating it from the product stream 44. The product stream 44 may be further cooled in the first iodine removal vessel 50a to a temperature below the melting point of the iodine to separate even more iodine from the product stream 44, depositing at least some of the iodine within the first iodine removal vessel 50a as a solid and producing a reduced iodine product stream 52. The reduced iodine product stream 52 may be provided to the second iodine removal vessel 50b and cooled to separate at least some more of the iodine from the reduced iodine product stream 52 to produce a further crude hydrogen iodide product stream 54.

Although the first iodine removal train 48a consists of two iodine removal vessels operating in a series configuration, it is understood that the first iodine removal train 48a may include two or more iodine removal vessels operating in a parallel configuration, more than two iodine removal vessels operating in a series configuration, or any combination thereof. It is also understood that the first iodine removal train 48a may consist of a single iodine removal vessel. It is further understood that any of the iodine removal vessels may include, or be in the form of, heat exchangers. It is also understood that consecutive vessels may be combined into a single vessel having multiple cooling stages.

The iodine collected in the first iodine removal vessel 50a may form a first iodine recycle stream 56a. Similarly, the iodine collected in the second iodine removal vessel 50b may form a second iodine recycle stream 56b. Each of the first iodine recycle stream 56a and the second iodine recycle stream 56b may be provided continuously or intermittently to the iodine liquefier 20, as shown, and/or to the iodine vaporizer 24.

In order to provide continuous operation while collecting the iodine in solid form, the upstream valve 46 may be configured to selectively direct the product stream 44 to a second iodine removal train 48b. The second iodine removal train 48b may be substantially similar to the first iodine removal train 48a, as described above. Once either the first iodine removal vessel 50a or the second iodine removal vessel 50b of the first iodine removal train 48a accumulates enough solid iodine that it is beneficial to remove the solid iodine, the upstream valve 46 may be selected to direct the product stream 44 from the first iodine removal train 48a to the second iodine removal train 48b. At about the same time, a downstream valve 58 configured to selectively direct the crude hydrogen iodide product stream 54 from either of the first iodine removal train 48a or the second iodine removal train 48b may be selected to direct the crude hydrogen iodide product stream 54 from the second iodine removal train 48b so that the process of removing the iodine from the product stream 44 to produce the crude hydrogen iodide product stream 54 may continue uninterrupted. Once the product stream 44 is no longer directed to the first iodine removal train 48a, the first iodine removal vessel 50a and the second iodine removal vessel 50b of the first iodine removal train 48a may be heated to above the melting point of the iodine, liquefying the solid iodine so that it may flow through the first iodine recycle stream 56a and the second iodine recycle stream 56b of the first iodine removal train 48a to the iodine liquefier 20.

As the process continues and either of the first iodine removal vessel 50a or the second iodine removal vessel 50b of the second iodine removal train 48b accumulates enough solid iodine that it is beneficial to remove the solid iodine, the upstream valve 46 may be selected to direct the product stream 44 from the second iodine removal train 48b back to the first iodine removal train 48a, and the downstream valve 58 may be selected to direct the crude hydrogen iodide product stream 54 from the first iodine removal train 48a so that the process of removing the iodine from the product stream 44 to produce the crude hydrogen iodide product stream 54 may continue uninterrupted. Once the product stream 44 is no longer directed to the second iodine removal train 48b, the first iodine removal vessel 50a and the second iodine removal vessel 50b of the second iodine removal train 48b may be heated to above the melting point of the iodine, liquefying the solid iodine so that it may flow through the first iodine recycle stream 56a and the second iodine recycle stream 56b of the second iodine removal train 48b to the iodine liquefier 20. By continuing to switch between the first iodine removal train 48a and the second iodine removal train 48b, the unreacted iodine in the product stream 44 may be efficiently and continuously removed and recycled.

As described above, the liquid iodine may flow through the first iodine recycle streams 56a and the second iodine recycle streams 56b of the first iodine removal train 48a and the second iodine removal train 48b to the iodine liquefier 20. Alternatively, the liquid iodine may flow through the first iodine recycle streams 56a and the second iodine recycle streams 56b of the first iodine removal train 48a and the second iodine removal train 48b to the iodine vaporizer 24, bypassing the iodine liquefier 20 and the liquid flow controller 26.

In the integrated process 10 shown in FIG. 1, the crude hydrogen iodide product stream 54 is provided to a first vessel 60. The first vessel 60 contains any of the solid adsorbents or liquid absorbents describe above as suitable for use with adsorbing or absorbing water from HI. Removing much of the water from the product stream 54 to produce a product stream 55 protects the downstream equipment from the corrosive effects of the water/HI combination. In some embodiments, the flow rate through the first vessel 60 is sufficient to overcome the initial high heat of adsorption, thereby maintaining the temperature of the purified hydrogen iodide (HI) and the desiccant bed at 65° C. or lower.

The product stream 55 from the first vessel 60 is provided to a compressor 80 to increase the pressure of the crude hydrogen iodide product stream 55 to facilitate the recovery of the hydrogen and the hydrogen iodide. The compressor 80 increases the pressure of the crude hydrogen iodide product stream 55 to a separation pressure, that is greater than an operating pressure of the reactor 42 to produce a compressed product stream 82. The compressed product stream 82 may pass through a second vessel 87 to produce a product stream 83. The second vessel 87 contains any of the solid adsorbents or liquid absorbents describe above as suitable for use with adsorbing or absorbing water from HI. The second vessel 87 may be in addition to, or in place of, the first vessel 60. In some embodiments, the flow rate through the second vessel 87 is sufficient to overcome the initial high heat of adsorption, thereby maintaining the temperature of the purified hydrogen iodide (HI) and the desiccant bed at 65° C. or lower.

The compressed product stream 83 is directed to a partial condenser 84 where it is subjected to a one-stage flash cooling for the separation of higher boiling point substances, such as hydrogen iodide and trace amounts of residual, unreacted iodine, from lower boiling point substances, such as the unreacted hydrogen. A recycle stream 86 including hydrogen and some hydrogen iodide from the partial condenser 84 may be recycled back to the reactor 40.

A bottom stream 88 from the partial condenser 84 including the hydrogen iodide, trace amounts of residual unreacted iodine and trace amounts of water may be provided to a product column 90. The product column 90 may be configured for the separation of the residual unreacted iodine and other higher boiling compounds from the hydrogen iodide. A bottom stream 92 of the product column 90 including the unreacted iodine may be recycled back to the iodine liquefier 20. Alternatively, the bottom stream 92 of the product column 90 including the unreacted iodine may be recycled back to the iodine vaporizer 24. The resulting purified hydrogen iodide product may be collected from an overhead stream 94 of the product column 90. A purge stream 96 may be taken from the product column 90 to control the build-up of low boiling impurities. A portion of the purge stream 96 may be recycled back to the reactor 40, while another portion may be disposed of. The overhead stream 94 and, optionally, a reflux stream (not shown) is provided to a third vessel 98 to produce a product stream 95. The third vessel 98 contains any of the solid adsorbents or liquid absorbents describe above as suitable for use with adsorbing or absorbing water from HI. The third vessel 98 may be in addition to, or in place of, either of the first vessel 60 or the second vessel 87. In some embodiments, the flow rate through the third vessel 98 is sufficient to overcome the initial high heat of adsorption, thereby maintaining the temperature of the purified hydrogen iodide (HI) and the desiccant bed at 65° C. or lower.

FIG. 2 is a process flow diagram showing another integrated process for manufacturing anhydrous hydrogen iodide. The integrated process 100 shown in FIG. 2 is the same as the integrated process 10 described above in reference to FIG. 1 except that the third vessel 98 is replaced with a separation device 102. The separation device may be an azeotropic distillation column configured for the removal of water from the HI. Alternatively, the separation device 102 may be a multi-stage flash system. The water is removed in a bottom stream 104. The bottom stream 104 is richer in water than the overhead stream 94. The bottom stream 104 may be further treated by any of the methods described above to remove water from the hydrogen iodide (HI) remaining in the bottom stream 104. Alternatively, or additionally, the bottom stream 104 may be disposed of.

While this invention has been described as relative to exemplary designs, the present invention may be further modified within the spirit and scope of this disclosure. Further, this application is intended to cover such departures from the present disclosure as come within known or customary practice in the art to which this invention pertains.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” is also considered as disclosing the range defined by the absolute values of the two endpoints.

The following non-limiting Examples serve to illustrate the disclosure.

### EXAMPLES

### Example 1: Adsorbent Selection

In this Example, a selection of adsorbents was tested by exposing the different adsorbents to water and hydrogen iodide (HI). The experiments were conducted at room temperature.

About 2 g of the adsorbent was charged to separate glass vials which were placed into a desiccator. The desiccant inside the desiccator was replaced with a beaker containing water. The cap of the desiccator was replaced, and the vent closed to isolate it from the surroundings. The adsorbents were exposed for three days. The adsorbents were analyzed by thermogravimetric analysis-mass spectrometry (TGA-MS), as shown in Table 1 below.

To analyze exposure to hydrogen iodide (HI), the adsorbents were placed in a 150 mL sample cylinder, which was pressure checked at 250 psig, then evacuated and charged with 150-200 g of hydrogen iodide (HI). The hydrogen iodide (HI) contained about 500 ppm of iodine (I₂). The sample cylinders were set upright at room temperature for 21 days. The exposed adsorbents included alumina (F200), molecular sieves (4A) made of synthetic zeolite, silica gel, hydrotalcite, and nickel(II) iodide (NiI₂) supported on alumina.

The appearance of the adsorbents after exposure to hydrogen iodide (HI) at room temperature for 21 days was used as an indication of their compatibility with hydrogen iodide (HI). The alumina, silica gel, and hydrotalcite were discolored, perhaps due to adsorption of the residual iodine (I₂) in the hydrogen iodide (HI), but appeared to be compatible with hydrogen iodide (HI).

Table 1 provides the water adsorption capacity at both STP (1 atm and 0° C.) and 52° C. for the adsorbents evaluate, as determined by TGA. Considering Table 1 and the appearance of the adsorbents as described above, the alumina, silica gel and nickel(II) iodide were found to be both compatible with hydrogen iodide (HI) and retain most of their water adsorbing capacity in the presence of hydrogen iodide (HI).

TABLE 1

| | H₂O | H₂O | H₂O/HI |
|---|---|---|---|
| | Capacity at | Capacity at | Capacity at |
| Material | STP, % | 52° C., % | 52° C., %^{b} |
| Silica (SiO₂) | 40 | 29.2 | 31.5 |
| Activated alumina | 20 | 12.7 | 11.7 |
| (F-200) | | | |
| Extruded | — | 13.5 | 1.67 |
| Hydrotalcite | | | |
| (Mg₄Al₂O₇) (dried)^{a} | | | |
| Molecular sieve (4A) | 20 | 14.3 | 12.9 |
| Spent NiI₂/Al₂O₃ | 35 | 20.8 | 27.8 |

^{a}Value obtained from desorption isotherm.
^{b}Capacity after competitive adsorption of water vapor.

### Example 2: Removal of Water from HI in the Vapor Phase

In this Example, the selectivity in the removal of water from HI is demonstrated. Into a glass container (an empty desiccator of about 3 L volume) were placed beakers containing 40 g of each adsorbent: F200 (activated alumina), CLR 204 (activated alumina), Sorbead WS (silica gel) with calcium nitrate, hydrotalcite (dried), hydrotalcite (calcined), and zinc phosphate (Zn₃(PO₄)₂). To each beaker, 80 g of a mixture of HI (57%) and water (43%) was added. The lid of the desiccator was sealed and the desiccator was maintained at ambient temperature (about 22-25° C.). At specified intervals, 1 g samples of the adsorbents were removed and analyzed to determine weight gains and the amount of adsorbed HI in each. The amount of adsorbed HI was derived from iodide concentration measured by on chromatography (IC) following extraction into water. The amount of water adsorbed was obtained by subtracting the weight of adsorbed HI from the total weight gain of the material. The data for each adsorbent is summarized in Tables 2-6, below. As can be seen from the data, all materials adsorb mainly water when exposed to 57% HI in water at room temperature and about 1 atm.

Table 2 shows adsorption of both water and hydrogen iodide (HI) for the F200 alumina adsorbent following exposure to 57% HI in water. In all cases, water was selectively (>99%) adsorbed.

TABLE 2

| Sam- | | Total | | | | | |
|---|---|---|---|---|---|---|---|
| ple | | Wt. | HI | | | | |
| Num- | Time | Gain | Conc. | HI Wt. | Water | % Water | % HI |
| ber | (hours) | (g) | (ppm) | (g) | Wt. (g) | Adsorbed | Adsorbed |
| 1A | 24 | 0.58 | 341 | 0.0002 | 0.5798 | 99.97 | 0.03 |
| 1B | 48 | 1.05 | 914 | 0.0015 | 1.0485 | 99.86 | 0.14 |
| 1C | 72 | 1.47 | 1208 | 0.0037 | 1.4663 | 99.75 | 0.25 |
| 1D | 95 | 1.82 | 1975 | 0.0097 | 1.8103 | 99.47 | 0.53 |
| 1E | 169 | 2.54 | 2040 | 0.0152 | 2.5248 | 99.40 | 0.60 |
| 1F | 193 | 2.74 | 1874 | 0.0191 | 2.7209 | 99.30 | 0.70 |
| 1G | 217 | 2.88 | 1550 | 0.0203 | 2.8597 | 99.30 | 0.70 |
| 1H | 241 | 3.09 | 102 | 0.0016 | 3.0884 | 99.95 | 0.05 |
| 1I | 266 | 3.2 | 2847 | 0.0551 | 3.1449 | 98.28 | 1.72 |
| 1J | 336 | 3.43 | 3616 | 0.0824 | 3.3476 | 97.60 | 2.40 |

Table 3 shows adsorption of both water and hydrogen iodide (HI) for the CLR-204 alumina adsorbent following exposure to 57% HI in water.

TABLE 3

| Sam- | | Total | | | | | |
|---|---|---|---|---|---|---|---|
| ple | | Wt. | HI | | | | |
| Num- | Time | Gain | Conc. | HI Wt. | Water | % Water | % HI |
| ber | (hours) | (g) | (ppm) | (g) | Wt. (g) | Adsorbed | Adsorbed |
| 2A | 24 | 0.28 | 1958 | 0.0005 | 0.2795 | 99.80 | 0.20 |
| 2B | 48 | 0.7 | 2348 | 0.0023 | 0.6977 | 99.67 | 0.33 |
| 2C | 72 | 1.04 | 4791 | 0.0097 | 1.0303 | 99.07 | 0.93 |
| 2D | 95 | 1.33 | 5403 | 0.0181 | 1.3119 | 98.64 | 1.36 |
| 2E | 169 | 2.03 | 12191 | 0.0656 | 1.9644 | 96.77 | 3.23 |
| 2F | 193 | 2.37 | 11076 | 0.0858 | 2.2842 | 96.38 | 3.62 |
| 2G | 217 | 2.55 | 17159 | 0.1767 | 2.3733 | 93.07 | 6.93 |
| 2H | 241 | 2.83 | 10336 | 0.1357 | 2.6943 | 95.20 | 4.80 |
| 2I | 266 | 2.96 | 11450 | 0.1842 | 2.7758 | 93.78 | 6.22 |
| 2J | 336 | 3.71 | 11558 | 0.2288 | 3.4812 | 93.83 | 6.17 |

Table 4 shows adsorption of both water and hydrogen iodide (HI) for the Sorbead WS (silica gel) with calcium nitrate adsorbent following exposure to 57% HI in water.

TABLE 4

| Sam- | | Total | | | | | |
|---|---|---|---|---|---|---|---|
| ple | | Wt. | HI | | | | |
| Num- | Time | Gain | Conc. | HI Wt. | Water | % Water | % HI |
| ber | (hours) | (g) | (ppm) | (g) | Wt. (g) | Adsorbed | Adsorbed |
| 1A | 48 | 0.49 | 92 | 0.0000 | 0.4900 | 99.99 | 0.01 |
| 1B | 144 | 1.18 | 2202 | 0.0026 | 1.1774 | 99.78 | 0.22 |
| 1C | 197 | 2.23 | 3400 | 0.0076 | 2.2224 | 99.66 | 0.34 |
| 1D | 289 | 2.52 | 3738 | 0.0094 | 2.5106 | 99.63 | 0.37 |
| 1E | 415 | 2.73 | 6998 | 0.0191 | 2.7109 | 99.30 | 0.70 |
| 1F | 626 | 2.97 | 7034 | 0.0209 | 2.9491 | 99.30 | 0.70 |

Table 5 shows adsorption of both water and hydrogen iodide (HI) for the dried hydrotalcite adsorbent following exposure to 57% HI in water.

TABLE 5

| Sam- | | Total | | | | | |
|---|---|---|---|---|---|---|---|
| ple | | Wt. | HI | | | | |
| Num- | Time | Gain | Conc. | HI Wt. | Water | % Water | % HI |
| ber | (hours) | (g) | (ppm) | (g) | Wt. (g) | Adsorbed | Adsorbed |
| 2A | 48 | 0.08 | 69 | 0.0000 | 0.0800 | 99.99 | 0.01 |
| 2B | 144 | 0.21 | 190 | 0.0000 | 0.2100 | 99.98 | 0.02 |
| 2C | 197 | 0.29 | 753 | 0.0002 | 0.2898 | 99.92 | 0.08 |
| 2D | 289 | 0.47 | 764 | 0.0004 | 0.4696 | 99.92 | 0.08 |
| 2E | 415 | 0.6 | 766 | 0.0005 | 0.5995 | 99.92 | 0.08 |
| 2F | 626 | 0.61 | 963 | 0.0006 | 0.6094 | 99.90 | 0.10 |

Table 6 shows adsorption of both water and hydrogen iodide (HI) for the zinc phosphate (Zn₃(PO₄)₂) adsorbent following exposure to 57% HI in water.

TABLE 6

| Sam- | | Total | | | | | |
|---|---|---|---|---|---|---|---|
| ple | | Wt. | HI | | | | |
| Num- | Time | Gain | Conc. | HI Wt. | Water | % Water | % HI |
| ber | (hours) | (g) | (ppm) | (g) | Wt. (g) | Adsorbed | Adsorbed |
| 1A | 47 | 0.53 | 0 | 0.0000 | 0.5300 | 100.00 | 0.00 |
| 1B | 143 | 0.86 | 53 | 0.0000 | 0.8600 | 99.99 | 0.01 |
| 1C | 194 | 1.06 | 240 | 0.0003 | 1.0597 | 99.98 | 0.02 |
| 1D | 242 | 0.97 | 356 | 0.0003 | 0.9697 | 99.96 | 0.04 |
| 1E | 314 | 1.15 | 456 | 0.0005 | 1.1495 | 99.95 | 0.05 |
| 1F | 362 | 1.27 | 1769 | 0.0022 | 1.2678 | 99.82 | 0.18 |
| 1G | 410 | 1.45 | 1010 | 0.0015 | 1.4485 | 99.90 | 0.10 |
| 1H | 482 | 1.57 | 2006 | 0.0031 | 1.5669 | 99.80 | 0.20 |
| 2I | 432 | 1.66 | 2750 | 0.0046 | 1.6554 | 99.73 | 0.28 |

### Example 3: Determination of Water Holding Capacity of Silicalite

The static moisture capacity of silicalite was analyzed by thermogravimetric analysis (TGA-MS) on a LabSys Evo TGA/DSC instrument available from Setaram (France). The TGA was performed using ramp and isothermal TGA, with helium as the bath gas. A 27.7 mg sample was analyzed with a sampling rate of 0.4 sec/pt and a sample mass flow control (MFC) rate of 50 mL/min of helium. The initial temperature was set to 30° C., after which the protocol was as follows: ramp at 10.00° C./min up to 250° C., hold at 250° C. for 4 hours, ramp at 10.00° C./min up to 600° C., hold at 600° C. for 1 hour, ramp at 50.00° C./min to 30° C.

Mass spectrometry (MS) was conducted on an Omnistar GCD320 instrument available from Pffiefer Vacuum. The analysis was conducted in scan mode with an m/z range of 4-300. The radio frequency (RF) polarity was positive, and a secondary electron multiplier (SEM) detector was used. The data sampling rate was 200 ms/amu, and blank was run before the sample.

The Al₂O₃ pans used for this instrument are soaked in 35% HCl overnight, rinsed with ultrapure H₂O, then baked in a furnace at 800° C. for over 8 hours to remove contaminants. All pans were stored in an oven at 125° C. before use.

The results of this analysis are shown in FIGS. 3 and 4. FIG. 3 shows that the initial mass of silicalite and water combined was 26 mg. After removal of water at 250° C. for 15,000 seconds, the mass of the dried silicalite was 21.0 mg. FIG. 4 shows the decline in the amount of water in the silicalite sample over time. The water holding capacity of dried silicalite is determined by dividing the difference between the two values by the mass of the dried silicate, then multiplying by 100 to find the weight percentage (23.8) as shown below in Equation 2.

[(26−21)/21]×100=23.8 wt. % Equation 2

This value indicates that every 100 pounds of dried silicalite can adsorb 23.8 lbs of water.

### Example 4: Removal of Water from HI with Silicalite

In this Example, the removal of water from a mixture of HI and water using a silicalite adsorbent can be demonstrated. A vessel having L/D ratio of 5:1 can be filled with 1000 pounds of freshly charged silicalite desiccant. A liquid HI mixture having 1000 ppm water by weight at 30° C. can be pumped into the vessel at a rate of 5 GPM. The exiting liquid HI mixture can contain less than 50 ppm water by weight. For a continuous dynamic operation, a conservative 50% of the static capacity is assumed to account for mass transfer, residual moisture content after regeneration, and loss of adsorption efficiency due to aging of adsorbent and/or co-adsorption of impurities.

Alternatively, the drying operation described above can also be carried out by circulating the liquid HI mixture from a container at higher flowrate (e.g., 50 GPM) until the HI mixture has reached the desired water concentration level in the container.

Specifically, the adsorbent, silicalite, can be charged into a column and the crude, water-containing HI is circulated through the column to attain the desired purity. The HI can be supplied to the column in the gas or liquid phase. Preferably, the circulation is performed at room temperature. This method may precede an optional distillation as a final treatment step to make high purity hydrogen iodide (HI).

### Example 5: Removal of Water from Liquid HI with Activated Alumina

In this Example, the removal of water from a mixture of water and HI using an alumina adsorbent can be demonstrated. A vessel having an L/D ratio of 5:1 can be filled with 1000 pounds of freshly charged activated alumina desiccant. A liquid hydrogen iodide (HI) mixture having a water content of 1000 ppm by weight at 30° C. can be pumped into the vessel at a rate of 50 GPM. This flow rate can be sufficient to overcome the initial high heat of adsorption, thereby maintaining the temperature of the purified liquid hydrogen iodide (HI) and the desiccant bed at 65° C. or lower.

### Example 6: Removal of Water with a Weak Acid

In this Example, the removal of water from a mixture of water and HI using phosphoric acid (H₃PO₄) can be demonstrated. Based on similar methods for drying fluorocarbons with sulfuric acid (H₂SO₄) and adjusting for the higher water partial pressure of phosphoric acid (H₃PO₄), it is estimated that the method of this Example will result in hydrogen iodide (HI) with a water content of less than 100 ppm by weight.

Hydrogen iodide (HI) vapor with a water content of 2500 ppm by weight can be passed through a counter-current packed tower from the bottom at a rate of 1000 lbs/hr and operating at 25° C. and 60 psia. Ninety-four percent phosphoric acid (H₃PO₄) can be circulated from the top of the tower. The rate for circulating phosphoric acid (H₃PO₄) is calculated to be about 10,000 lb/hr in order to achieve both sufficient liquid distribution and mass transfer. Typically, a reservoir of 200 gallons or 2500 lbs of 94% wt. phosphoric acid (H₃PO₄) for this scale is used until the circulating phosphoric acid (H₃PO₄) has reached 90% wt. phosphoric acid (H₃PO₄), at which time the spent acid will be disposed of and replaced with a fresh aliquot. The estimated consumption of 94% wt. phosphoric acid (H₃PO₄) is 60 pounds per 1000 pounds of hydrogen iodide (HI). A recovered 997.5 lbs of product contains about 997.5 lbs of hydrogen iodide (HI) and about 0.06 lbs of water, or approximately 60 ppm water.

Depending upon the packing type and size, a packed tower of approximately 18 inches in diameter and 18 feet in height is sufficient to carry out the drying process for hydrogen iodide (HI) vapor at a rate of 1000 lb/hr.

### Example 7: Removal of Water from Liquid HI via Azeotropic Distillation

In this Example, the removal of water from a mixture of water and HI using azeotropic distillation is demonstrated. Using an Aspen simulation, it is estimated that the method described in this Example will result in hydrogen iodide (HI) with a water content of less than 10 ppm by weight.

One thousand pounds of hydrogen iodide (HI) with a water content of 2500 ppm by weight can be fed to a distillation column having three theoretical stages, plus a reboiler and a condenser. The operating reflux ratio specification is given as 0.3 on a mass basis and the operating pressure is given as 115 psia. Under these operating conditions, the estimated HI recovery from the column overhead is greater than 99%, with less than 10 ppm water by weight. The distillation column bottom will contain less than 10 lb/hr HI and 2.5 lb/hr water.

### Example 8: Removal of Water from Liquid HI via Single Stage Flash

In this Example, the removal of water from a mixture of water and HI using a single stage flash is demonstrated. Using an Aspen simulation, it is estimated that the method in this Example will result in hydrogen iodide (HI) with a water content of less than 400 ppm by weight.

One thousand pounds of liquid hydrogen iodide (HI) with a water content of 2500 ppm by weight will be fed to a single stage flash unit at an operating pressure of 115 psia. In the unit, 96.4% of the incoming hydrogen iodide (HI) is flashed to the top, leaving water at the bottom.

### ASPECTS

Aspect 1 is a method of removing water from a mixture of hydrogen iodide (HI) and water. The method includes providing a mixture comprising hydrogen iodide and water, and contacting the mixture with an adsorbent to selectively adsorb water from the mixture.

Aspect 2 is the method of Aspect 1, wherein in the providing step, the mixture has a water concentration of from about 100 ppm to about 2,500 ppm.

Aspect 3 is the method of Aspect 1, wherein in the providing step, the mixture has a water concentration of from about 200 ppm to about 2,200 ppm.

Aspect 4 is the method of Aspect 1, wherein in the providing step, the mixture has a water concentration of from about 600 ppm to about 1,800 ppm.

Aspect 5 is the method of Aspect 1, wherein in the providing step, the mixture has a water concentration of from about 600 ppm to about 1,600 ppm.

Aspect 6 is the method of any of Aspects 1-5, wherein in the contacting step, the mixture is in the vapor phase.

Aspect 7 is the method of any of Aspects 1-5, wherein in the contacting step, the mixture is in the liquid phase.

Aspect 8 is the method of any of Aspects 1-7, wherein the adsorbent is selected from the group consisting of: nickel(II) iodide (NiI₂), activated alumina, natural or synthetic zeolites, silica gel, hydrotalcites, zinc phosphate (Zn₃(PO₄)₂), silicalite and calcium sulfate (CaSO₄).

Aspect 9 is the method of any of Aspects 1-7, wherein the adsorbent is selected from the group consisting of: nickel(II) iodide (NiI₂), activated alumina, natural or synthetic zeolites, silica gel, zinc phosphate (Zn₃(PO₄)₂) and silicalite.

Aspect 10 is method of any of Aspects 1-7, wherein the adsorbent is selected from the group consisting of: activated alumina and silica gel.

Aspect 11 is the method of any of Aspects 1-7, wherein the adsorbent includes nickel(II) iodide (NiI₂).

Aspect 12 is the method of any of Aspects 1-11, further comprising regenerating the adsorbent by heating the adsorbent to a temperature from 150° C. to 350° C.

Aspect 13 is method of any of Aspects 1-12, wherein after the contacting step, the water content of the mixture is 500 ppm or less by weight.

Aspect 14 is method of any of Aspects 1-12, wherein after the contacting step, the water content of the mixture is 100 ppm or less by weight.

Aspect 15 is method of any of Aspects 1-12, wherein after the contacting step, the water content of the mixture is 10 ppm or less by weight.

Aspect 16 is method of any of Aspects 1-12, wherein after the contacting step, the water content of the mixture is 1 ppm or less by weight.

Aspect 17 is a method of removing water from a mixture of hydrogen iodide (HI) and water. The method includes providing a mixture comprising hydrogen iodide and water, and contacting the mixture with a weak acid to absorb water from the mixture.

Aspect 18 s the method of Aspect 17, wherein in the providing step, the mixture has a water concentration of from about 100 ppm to about 2,500 ppm.

Aspect 19 is the method of Aspect 17, wherein in the providing step, the mixture has a water concentration of from about 200 ppm to about 2,200 ppm.

Aspect 20 is the method of Aspect 17, wherein in the providing step, the mixture has a water concentration of from about 600 ppm to about 1,800 ppm.

Aspect 21 is the method of Aspect 17, wherein in the providing step, the mixture has a water concentration of from about 600 ppm to about 1,600 ppm.

Aspect 22 is the method of any of Aspects 17-21, wherein the weak acid is selected from the group consisting of phosphoric acid (H₃PO₄), meta-phosphoric acid (HPO₃), and acetic acid.

Aspect 23 is the method of Aspect 22, wherein the weak acid consists of phosphoric acid (H₃PO₄).

Aspect 24 is the method of any of Aspects 17-23, wherein in the contacting step, the mixture contacts the weak acid in a contactor selected from the group consisting of: a bas-liquid mixing contactor, a counter-current packed or trayed column, a co-current packed or trayed column, a liquid-liquid mixing contactor, a mixing vessel and an eductor.

Aspect 25 is the method of any of Aspects 17-24, wherein after the contacting step, the water content of the mixture is 500 ppm or less by weight.

Aspect 26 is the method of any of Aspects 17-24, wherein after the contacting step, the water content of the mixture is 100 ppm or less by weight.

Aspect 27 is the method of any of Aspects 17-24, wherein after the contacting step, the water content of the mixture is 10 ppm or less by weight.

Aspect 28 is the method of any of Aspects 17-24, wherein after the contacting step, the water content of the mixture is 1 ppm or less by weight.

Aspect 29 is a method of removing water from a mixture of hydrogen iodide (HI) and water. The method includes providing a mixture of hydrogen iodide and water, and separating the water from hydrogen iodide (HI) by azeotropic distillation to produce anhydrous hydrogen iodide (HI).

Aspect 30 is the method of Aspect 29, wherein in the providing step, the mixture has a water concentration of from about 100 ppm to about 2,500 ppm.

Aspect 31 is the method of Aspect 29, wherein in the providing step, the mixture has a water concentration of from about 200 ppm to about 2,200 ppm.

Aspect 32 is the method of Aspect 29, wherein in the providing step, the mixture has a water concentration of from about 600 ppm to about 1,800 ppm.

Aspect 33 is the method of Aspect 29, wherein in the providing step, the mixture has a water concentration of from about 600 ppm to about 1,600 ppm.

Aspect 34 is the method of any of Aspects 29-33, wherein in the separating step, the azeotropic distillation includes a multi-stage flash.

Aspect 35 is the method of any of Aspects 29-34, wherein in the separating step, the pressure of the azeotropic distillation is from about 10 psia to about 400 psia.

Aspect 36 is the method of any of Aspects 29-34, wherein in the separating step, the pressure of the azeotropic distillation is from about 80 psia to about 300 psia.

Aspect 37 is the method of any of Aspects 29-34, wherein in the separating step, the pressure of the azeotropic distillation is from about 100 psia to about 250 psia.

Aspect 38 is the method of any of Aspects 29-34, wherein in the separating step, the pressure of the azeotropic distillation is from about 150 psia to about 200 psia.

Aspect 39 is the method of any of Aspects 29-38, wherein in the separating step, the temperature of the azeotropic distillation is from about −45° C. to about 60° C.

Aspect 40 is the method of any of Aspects 29-38, wherein in the separating step, the temperature of the azeotropic distillation is from about 15° C. to about 60° C.

Aspect 41 is the method of any of Aspects 29-38, wherein in the separating step, the temperature of the azeotropic distillation is from about 25° C. to about 55° C.

Aspect 42 is the method of any of Aspects 29-38, wherein in the separating step, the temperature of the azeotropic distillation is from about 40° C. to about 50° C.

Aspect 43 is the method of any of Aspects 29-42, wherein after the separating step, the water content of the mixture is 500 ppm or less by weight.

Aspect 44 is the method of any of Aspects 29-42, wherein after the separating step, the water content of the mixture is 100 ppm or less by weight.

Aspect 45 is the method of any of Aspects 29-42, wherein after the separating step, the water content of the mixture is 10 ppm or less by weight.

Aspect 46 is the method of any of Aspects 29-42, wherein after the separating step, the water content of the mixture is 1 ppm or less by weight.

Aspect 47 is a method of removing water from a mixture of hydrogen iodide (HI) and water. The method includes providing a mixture comprising hydrogen iodide and water, the mixture having a water concentration of from about 600 ppm to about 1,600 ppm; and contacting the mixture with an adsorbent to selectively adsorb water from the mixture, wherein after the contacting step, the water content of the mixture is 1 ppm or less by weight.

Aspect 48 is a method of removing water from a mixture of hydrogen iodide (HI) and water. The method includes providing a mixture comprising hydrogen iodide and water, the mixture having a water concentration of from about 600 ppm to about 1,600 ppm; and contacting the mixture with a weak acid to absorb water from the mixture, wherein after the contacting step, the water content of the mixture is 1 ppm or less by weight.

Aspect 49 is a method of removing water from a mixture of hydrogen iodide (HI) and water. The method includes providing a mixture of hydrogen iodide and water, the mixture having a water concentration of from about 600 ppm to about 1,600 ppm; and separating the water from hydrogen iodide (HI) by azeotropic distillation to produce anhydrous hydrogen iodide (HI), the pressure of the azeotropic distillation from about 150 psia to about 200 psia, and the temperature of the azeotropic distillation from about 40° C. to about 50° C., wherein after the separating step, the water content of the mixture is 1 ppm or less by weight.

What is claimed is:

1. A method of removing water from a mixture of hydrogen iodide (HI) and water, the method comprising:
providing a mixture comprising hydrogen iodide and water; and
contacting the mixture with an adsorbent to selectively adsorb water from the mixture.

2. The method of claim 1, wherein in the providing step, the mixture has a water concentration of from about 100 ppm to about 2,500 ppm.

3. The method of claim 1, wherein in the contacting step, the mixture is in the vapor phase.

4. The method of claim 1, wherein in the contacting step, the mixture is in the liquid phase.

5. The method of claim 1, wherein the adsorbent is selected from the group consisting of: nickel(II) iodide (NiI₂), activated alumina, natural or synthetic zeolites, silica gel, hydrotalcites, zinc phosphate (Zn₃(PO₄)₂), silicalite and calcium sulfate (CaSO₄).

6. The method of claim 1, wherein the adsorbent is selected from the group consisting of: nickel(II) iodide (NiI₂), activated alumina, natural or synthetic zeolites, silica gel, zinc phosphate (Zn₃(PO₄)₂) and silicalite.

7. The method of claim 1, wherein the adsorbent is selected from the group consisting of: activated alumina and silica gel.

8. The method of claim 1, wherein the adsorbent includes nickel (II) iodide (NiI₂).

9. The method of claim 1, further comprising regenerating the adsorbent by heating the adsorbent to a temperature from 150° C. to 350° C.

10. The method of claim 1, wherein after the contacting step, the water content of the mixture is 500 ppm or less by weight.

11. A method of removing water from a mixture of hydrogen iodide (HI) and water, the method comprising:
providing a mixture comprising hydrogen iodide and water; and
contacting the mixture with a weak acid to absorb water from the mixture.

12. The method of claim 11, wherein in the providing step, the mixture has a water concentration of from about 100 ppm to about 2,500 ppm.

13. The method of claim 11, wherein the weak acid is selected from the group consisting of phosphoric acid (H₃PO₄), meta-phosphoric acid (HPO₃), and acetic acid.

14. The method of claim 11, wherein in the contacting step, the mixture contacts the weak acid in a contactor selected from the group consisting of: a bas-liquid mixing contactor, a counter-current packed or trayed column, a co-current packed or trayed column, a liquid-liquid mixing contactor, a mixing vessel and an eductor.

15. The method of claim 11, wherein after the contacting step, the water content of the mixture is 500 ppm or less by weight.

16. A method of removing water from a mixture of hydrogen iodide (HI) and water, the method comprising:
providing a mixture of hydrogen iodide and water; and
separating the water from hydrogen iodide (HI) by azeotropic distillation to produce anhydrous hydrogen iodide (HI).

17. The method of claim 16, wherein in the providing step, the mixture has a water concentration of from about 100 ppm to about 2,500 ppm.

18. The method of claim 16, wherein in the separating step, the azeotropic distillation includes a multi-stage flash.

19. The method of claim 16, wherein in the separating step, the pressure of the azeotropic distillation is from about 10 psia to about 400 psia.

20. The method of claim 16, wherein after the contacting step, the water content of the mixture is 500 ppm or less by weight.
